(19) United States
(12) Patent Application Publication
(10) Pub. No.: US 2002/0178234 A1
(43) Pub. Date: Nov. 28, 2002

(54) Browser software

(76) Inventor: Philip Alan Birchley, Suffolk (GB)

Correspondence Address: Bourque & Associates, P.A., Suite 301, 835 Hanover Street, Manchester, NH, 03104, US

(21) Appl. No.: 10/090,891

(22) Filed: Mar. 5, 2002

(30) Foreign Application Priority Data
Mar. 6, 2001 (GB) 0105470.9
Oct. 2, 2001 (GB) 0123558.9

(51) Int. Cl. G06F 15/16

(52) U.S. Cl. 709/217; 709/239

(57) ABSTRACT

The present invention provides a method, and software for performing the method, that enables a user to open a plurality of remote data resources (e.g. a web page) by accessing a single remote resource. The plurality of remote data resources may be defined as a group, with the selection of a single group member causing the entire group to be opened. Alternatively, a number of resource locators may be generated from a single locator by, for example, replacing a generic portion of the locator (e.g. .com) with further generic portions (e.g. .org, .co.uk, .edu) or by replacing a distinctive portion (e.g. cars) with generated variants (e.g. car, autos, automobiles, etc.).

The invention relates to web browsers used to download web pages from the internet to computers, such as the ‘Netscape Navigator’ browser. The invention is also applied in programs installed on websites.

At present, if a computer user wants to download and view a website on their computer, they have to type the web address (U.R.L.) or domain name into the web browser that they use, click on a web site link or select the website from the bookmarks (or favourites') menu on the browser. It is possible to have more than one browser session operating at once on a computer, but to see different web sites, the domain names have to be selected separately for each web browser session running. Programs do exist at present on websites that open up new browser sessions when old browser sessions are closed.

The problem with existing web browsers is that if users want to view websites with similar domain names to the one that they typed into their browser session or selected from the bookmarks menu initially, firstly they have to open separate browser sessions manually. Following this they have to guess similar domain names that they expect to have web sites attached to them, unless they know that a particular site exists and manually type these names into the other browser sessions or select them from a drop down browser menu. This is a time consuming process. Furthermore, if users type in domain names that they have guessed, they may not find a website attached to the name. This wastes more of their time.

According to a first aspect of the invention there is provided a method of accessing a plurality of remote data resources, the method comprising the steps of: receiving a locator for a single remote data resource; identifying a generic portion of said single remote data resource locator and a distinctive portion of said single remote data resource locator; modifying the generic portion or the distinctive portion of said single remote data resource locator to create one or more new remote data resource locators; and accessing the remote data resources located by the received single remote data resource locator and said one or more created remote data resource locators.

The single remote data resource locator may be translated into one or more different languages and a new generic portion is selected for each translated distinctive remote data resource locator in accordance with the translation language. The one or more further generic remote data resource locator portions are generated and each of said generated generic portions may be combined with the distinctive portion of said single remote data resource to create one or more new remote data resource locators. The one or more further generic remote data resource locator portions may be chosen randomly from a plurality of generic remote data resource locator portions.

Alternatively the one or more further generic remote data resource locator portions may be chosen randomly from a plurality of generic remote data resource locator portions, each of said plurality of generic remote data resource locator portions having an equal probability of being chosen or each of said plurality of generic remote data locator resource portions may have a respective predetermined probability of being chosen. The respective predetermined probability of being chosen may be constant or it may be varied.

The one or more further generic portions may indicate a geographical location and the one or more further generic portions may indicate an organisational descriptor. The one or more further distinctive portions may be created by adding one or more generic sequence into said distinctive data resource locator portion or alternatively by removing one or more generic sequence from said distinctive data resource locator portion. The one or more further distinctive portions are created by processing said distinctive data resource locator portion to create one or more synonyms. Said single remote data resource locator may comprise solely a distinctive portion and a plurality of remote data resource locators are created by generating a plurality of generic remote data resource locator portions and combining these with said distinctive portion.

According to a second aspect of the invention there is provided a computer program arranged to receive a locator for a single remote data resource; identify a generic portion of said single remote data resource locator and a distinctive portion of said single remote data resource locator; modify the generic portion or the distinctive portion of said single remote data resource locator to create one or more new remote data resource locators; and access the remote data resources located by the received single remote data resource locator and said one or more created remote data resource locators.

According to a third aspect of the invention there is provided a computer terminal attached to a communications network arranged to receive a locator for a single remote data resource located on the communications network; identify a generic portion of said single remote data resource locator and a distinctive portion of said single remote data resource locator; modify the generic portion or the distinctive portion of said single remote data resource locator to create one or more new remote data resource locators; and access via the communications network the remote data resources located by the received single remote data resource locator and said one or more created remote data resource locators.

According to a fourth aspect of the invention there is provided a server attached to a communications network arranged to receive a locator for a single data resource located on the communications network; identify a generic portion of said single data resource locator and a distinctive portion of said single data resource locator; modify the generic portion or the distinctive portion of said single data resource locator to create one or more remote data resource locators; (i) serve via the communications network the data resource located by the received single data resource locator; and (ii) serve via the communications network the one or more data resource located by said respective one or more created remote data resource locators.

According to a fifth aspect of the invention there is provided a server attached to a communications network arranged to receive a locator for a single data resource located on the communications network; identifying one or more further remote data resource locators that are associated with said single remote data resource locator; and serve via the communications network said single remote data resource locator and said associated one or more remote data resource locators. Said associated one or more remote data resource locators are identified by a data set stored on a remote terminal.

According to a sixth aspect of the invention there is provided a method of accessing a plurality of remote data resources, the method comprising the steps of: receiving a single remote data resource locator; identifying one or more further remote data resource locators that are associated with said single remote data resource locator; and accessing said single remote data resource locator and said associated one or more remote data resource locators.

Said associated one or more remote data resource locators may be identified by a data set stored on a remote terminal. Said association of said one or more further remote data resource locators with said single remote data resource locator may be configured, and preferably may be configured by a user.

The invention will now be described, by way of example only, with reference to the following Figures in which:

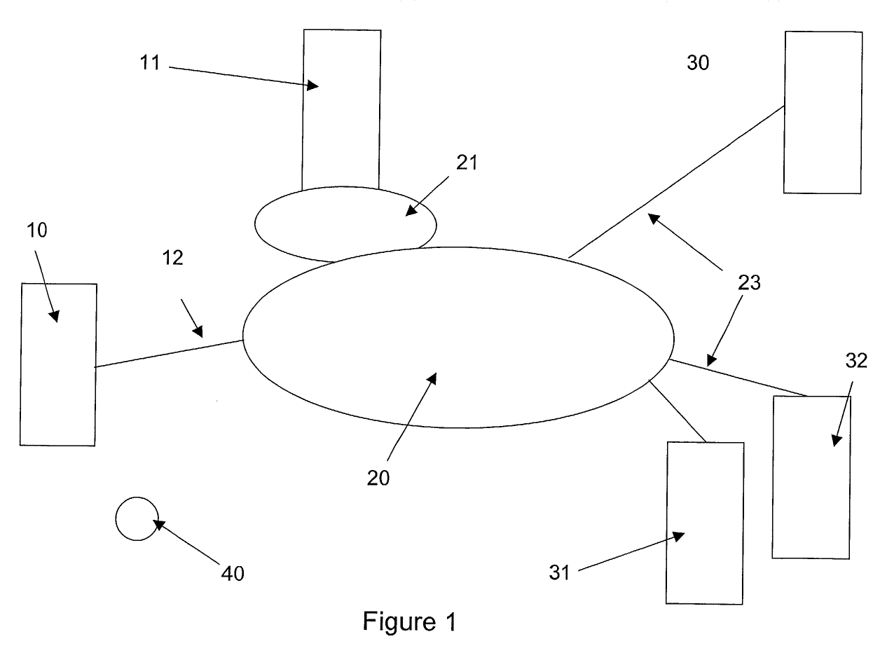

FIG. 1 is a schematic depiction of a terminal computer executing browser software according to the present invention;

FIG. 1 shows a terminal computer 10 which comprises conventional hardware and operating system software such that the computer 10 is able to execute a range of software application programs such as word processors, spreadsheets, etc., including a software browser according to the present invention. The terminal may be a conventional personal computer or device offering similar functionality such as a television set-top box, video games console, personal digital assistant or an internet-enabled mobile telephone handset. The terminal 10 is connected to a data communications network 20, such as an intranet or the internet, via communications link 12, which may be a dial-up connection made over a telephone network, a DSL connection, a wireless connection, etc. Alternatively terminal 11 is connected to local area network 21, which is connected to the data communications network 20. The data communications network 20 is connected to a plurality of remote data content servers 30, 31, 32 via communication links 23 (which be of any type suitable to transport sufficient data between the data communications network and the server). The remote servers may be geographically near to the terminal 10 or may be located in different countries, or even on different continents. The invention may be implemented on a computer-readable data carrier 40, such as a floppy disk, CD-ROM, DVD, etc.

The first part of the invention here is integrated with a browser's software program and is concerned with multiple browser sessions running simultaneously, either open or on the task bar, with different websites downloaded to them. The program activates a process whereby every time a domain name is typed into a browser's address box or selected from a menu of domains, this site downloads first by default. Following this, websites attached to other domains of the same name, but with different extensions or web sites with similar and related names are also automatically searched for and if found, downloaded to other browser sessions. Furthermore, website addresses are created based on the content of the initial web pages selected and then these addresses are modified before searches are conducted based on these modified, created domains.

For ease of explanation here, these are called the derivative domains, derivative websites, derivative browser sessions and derivative extensions. The derivative browser sessions appear on the task bar by default. There are further criteria for downloading derivative websites that are explained.

If the site initially selected by the user cannot be found for any reason, derivative websites are still searched for and downloaded if found.

An example of this aspect of the software functioning is if you originally type www.equity-dealer.com into a browser's address box the browser will identify the generic portions of the URL (.com) and the distinctive portion of the URL (equity-dealer). The browser will select a number of further generic portions and append these to the distinctive portion to generate a number of derivative URLs such that the following derivative sites will also automatically appear in different browser windows to be opened from the task bar (dependent on other factors): www.equity-dealer.co.uk; www.equity-dealer.net and www.equity-dealer.org.

The individual users of the web browsers that have this software in place will be able to specify how many different derivative browser sessions with derivative websites that they wish to appear on the task bar when they initially type in a domain name into the browser or select a domain name from a special drop down menu. However, the default setting is for two derivative websites with the same core domain names, but that have different extensions, to download to two different derivative browser sessions.

An option can be given so that users may elect for sex domains to not be selected by the browser.

At present there are about 300 different domain extensions. The factors which determine how often the different extensions for derivative domain names arise are predetermined by default and entered into the software by the makers, not the users. Each domain extension required is allotted a priority weighting, which simply acts as a limit to the number of derivative domain names with those extensions that are selected and successfully searched for due to the initial derivative search process, so that the associated derivative websites are downloaded, when a domain name is first selected. Initial derivative searches take place downward through the domain extension weightings table, followed by extra derivative searches, to be explained.

For example, it can be structured:

| Domain Extension. | Percentage Weighting. |
|---|---|
| .net | 25 |
| .tv | 22 |
| .com | 18 |
| .org | 9 |
| .co.uk | 8 |
| .cc | 7 |
| .mu | 3 |
| .de | 2 |
| .com.uk | 2 |
| .nz | 1 |
| Random | 3 |
| (Extension) | |

The higher the domain extension in the list, the higher the priority it takes.

So if a user types in a domain, such as www.money-com.eu this site will download first and up to 25% of the time the www.money.net version of this may appear in another browser window from the initial derivative search process. The .tv version may also appear in another browser window up to 22% of the time from the initial derivative search process. The .com version may appear up to 18% of the time from the initial derivative search process, in another browser window and so on.

To ensure that the weightings apply properly, the software counts and keeps record of how many times different extensions have been used for the derivative domain names for derivative browser sessions, found as a result of the initial derivative search process, after a domain name is originally selected by the user. Only successful derivative website downloads from the initial derivative search processes count against the weightings. The record is kept by default in a file on the browser user's computer. Each record made will be specific to the individual user or computer.

If the weighting limit for initial derivative searches for a specific domain extension has been reached, the initial derivative search process moves down the list to search for derivative domains with the next extension that has not reached its weighting limit for initial searches.

If a domain name is entered into the browser whose extension has a weighting in the list, for example, the user selects www.finance.com, then the exact .com version of this name will not appear again in another browser session. The program will instead select the website in the next domain extension down in the priority list that has not reached its weighting limit for initial searches. In the case above www.finance.org may be selected instead of reselecting the .com version.

Furthermore, assuming that a domain is entered into a browser, such as www.cats.com, if there is no derivative web site for the same domain name with a specific different extension, for example, if www.cats.net did not exist, then the browser looks to the next domain extension down in the weighting list, so www.cats.tv would be searched for, given the example weightings in the table above. The default setting is for the program to search up to a maximum of six different extensions on the initial derivative search, in order to find derivative websites with the same core domain name as initially selected by the user. This can be altered by the user to varying numbers of attempts, to the extent that the program can progressively look to each of the domain extensions below in priority until the lowest priority domain extension is checked to see if there is a derivative site that can be downloaded.

In a further alternative, a website address is entered into a browser program and the associated data resource is downloaded. The content of the downloaded data resource can be analysed to determine the most frequently used words or terms (excluding common words such as ‘the’, ‘a’, etc. that do not serve to characterise the content of the data resource). The most frequently used words can be used as the distinctive portion of new URL with generic portions being selected as described in the present application. The URLs can then be searched for and downloaded.

A derivative domain name searched for by the browser software may not exist either on internet domain name service (D.N.S.) servers or there may be no server hosting a website for that domain at the time.

By default, a limit is set for the time spent by the program trying to locate and download all types of derivative website, for each original site selected by the user. This time limit can be increased by the user.

As can be seen in the above table, there is a ‘random extension’ selection that is programmed in. This works by simply selecting derivative web sites with same core name but with any extension from the list of extensions programmed in. If a derivative site is not found for the random selection on first attempt, the program looks again for a website attached to a domain of the same name but of a different extension. By default, the program will make six attempts to find a random site to download. Again this can be modified, to the extent that the search can be activated to continue until a site is found or until the lowest priority domain extension is checked. The programmed weightings given to the domain extensions checked within the random selection can be equal. An option can be provided so that the random extension selection of derivative sites can be enabled or disabled by the user.

If two derivative websites are not found after the initial derivative search process through the domain extensions that have not reached their maximum initial search level weightings, once an individual domain name has originally been selected, the program goes back to the top of the weightings list and starts extra searches for derivative sites. The extra searches are based on those extensions that were not checked on the initial search because domain names with those extensions had been found to their weighting limit on previous occasions. These extra searches for derivative sites, due to other derivative sites not being found from the initial searches, do not count against the weightings for the extensions. The extra searches made are spread evenly across the extensions that have reached their weighting limit for initial searches, starting with higher priority extensions and working downwards.

After every 100 derivative websites that successfully download from both initial and extra searches combined, the counts for the number of derivative websites found after the initial and extra search processes are zeroed and the counting starts again.

For example, if the net extension has a 25% weighting, as in the table and derivative websites with the net extension had been selected 25 times in the last thirty initial derivative searches, domain names with the net extension would not be searched for again in initial derivative searches for derivative sites until the count for the number of derivative websites found after the search processes is zeroed and starts again. However, derivative websites with the net extension would be searched for in the extra searches, if derivative websites could not be found after all the other extension categories had been checked on the initial derivative search processes.

This process of initial and extra derivative searches, applies to the selection of all derivative websites detailed, unless otherwise stated.

An overall example of a situation that may arise can be described with the use of the following table. The example data in the domain extension and percentage weighting columns would be fixed in the program, but the data in the initial searches and extra searches columns is variable and represents the numbers of successful searches for both types of search which could arise after 100 successful derivative searches.

| Domain | Percentage | Initial | Extra |
|---|---|---|---|
| Extension | Weighting | Searches | Searches |
| .net | 25 | 25 | 4 |
| .tv | 22 | 17 | |
| .com | 18 | 18 | 3 |
| .org | 9 | 9 | 3 |
| .co.uk | 8 | 8 | 2 |
| .cc | 7 | 5 | |
| .mu | 3 | 1 | |
| .de | 2 | 0 | |
| .com.uk | 2 | 1 | |
| .nz | 1 | 0 | |
| Random | 3 | 3 | 1 |
| (Extension) | | | |

Total Successful Searches: 87+13=100.

In the above example, derivative sites with the same core name to those originally selected by the user, but with the .tv extension could only be found 17 times, so the initial search process moved onto the next domain extension down.

When the extensions had reached their limits for derivative searches, these extensions would have been missed out on initial searches and again, the initial search process moved onto the next extension down.

Eventually, when initial searches did not produce two derivative sites, due to unsuccessful searches and the bypassing of extensions that had reached their weighting limit, extra searches were conducted. Note that the extra searches were based on extensions that had reached their weighting limit for initial searches.

After the 100 successful derivative searches above, the records in the initial searches and extra searches columns would be zeroed.

As a whole, the section of the program which is dedicated to locating derivative websites that have the same core name as the ones typed into the browser or selected from a drop down menu, but different extensions, can be enabled or disabled by the user.

A further aspect of the program is that by default, two of the derivative browser sessions appearing on the task bar that have derivative websites downloaded to them are dedicated to domain names that are similar to those selected in the browser initially. For example, if www.cityjobs.tv is typed into the browser or selected from the special draw down menu, www.cityjobs.tv will download to a browser and alongside this, the derivative sites downloaded to other browser session could be www.cityjobs.com or www.ecityjobs.co.uk.

The search processes for the similar derivative domain names are based on the system described, including the weighting based initial derivative searches, followed by extra searches, as detailed, if required.

The aspect of the program that deals with selecting a similar domain name to try and download its website in a different browser session, incorporates the ability to look for websites with misspellings and additional letters in the domain name, such as the addition of an ‘e’ or ‘the’ at the front of names, the addition of hyphens ‘-’ anywhere in the domain names and the addition of an ‘s’ or ‘es’ at the end of domain names. By default, if a website with a similar core domain name cannot be found attached to a specific extension, such as .com, then another site with another similar domain name under the same extension will be searched for. By default, if from two searches a similar site cannot be found under the specific domain extension such as .com, the program moves onto the next domain extension, such as org to look for similar sites with that extension. The number of searches made for each domain extension can be modified by the user.

By default, up to six initial searches are attempted overall for similar domains. Again, this can be modified by the user and there is a time limit for locating and downloading each site. This time limit can be increased by the user.

As a whole, the section of the program which is dedicated to locating derivative websites with similar domain names can be enabled or disabled by the user.

A further aspect of the invention that can be enabled is for derivative browser sessions to be generated for downloading websites for domain names selected at random by the software attached to the web browser. The length of the random names can be determined by the user entering some text into the browser's address box. The length of the text determines the length of the random domain name for the derivative website to be searched for. The user can enable or disable this function by clicking on a selection box on the browser or via selections made from drop down menus.

The above method for selecting random domains by the program is based on random dictionary searches. If a website for a particular random domain name selected cannot be found, another will be searched for. The attempts are set at three by default but can be changed by the user.

Again, the search processes for these derivative domain names are based on the system described previously, including the weighting based initial derivative searches, followed by extra searches, as detailed, if required.

Whilst there are more websites with a .com extension than with any other individual extension, the .com extension can be given the majority of the weighting.

An alternative implementation of the random website selection process is based on the generation by the program of random numbers, as can be performed by some handheld calculators, in order to generate I. P. addresses for websites to be located by the software.—Each website has its own fixed I. P. address on the network.

The entire function of selecting random websites to appear in new browser sessions can be enabled or disabled by the user.

Further derivative browser sessions, to be described here, are generated if enabled by the user, for exact language translations of the domain names initially selected and for language translations of names similar to those selected. As described previously, names can initially be selected by either typing them into a browser window manually or by selecting them from a special drop down menu.

When a website address is selected, this specific website downloads first and the program attached to the browser session makes exact translations of this website address into other languages, allots domain extensions to the translated names, based on the languages being translated to and searches for websites with the new derivative domain names. The name is translated using a dictionary attached to the program.

Once the program has searched for derivative domains based on the extension relevant to the language of domain name being searched for, such as .fr for French names, the search processes for these derivative domain names then becomes based on the system described previously, of the weighting based initial derivative searches, followed by extra searches, as detailed, if required.

There are two possible implementations of the process whereby websites with translated similar names are found. Under the first system, the website initially selected is first downloaded and the domain is translated by the program into the appropriate language and then the program generates similar names, attaches the appropriate domain extension and searches for websites linked to those names found. Under the second implementation, the website initially selected is first downloaded and the program generates similar names to this domain name, then the program translates these similar names, the program adds the extensions and websites for the resultant domain names are searched for.

The language of the translations to be made by the program can be chosen by the user. The user will simply have to designate the original language and the translated language.

The user may select for derivative browser sessions to be searched for, for more than one language. For example, the user may make a selection for derivative browser sessions to appear for translations to French, German and Swedish, from English names originally selected.

The user may select how many derivative browser sessions that they wish to appear for exactly translated names and similar names translated for each language. For example, the user can elect for two derivative browser sessions to download for similar names translated from English to French, so if the user selects dog.com then le-chien.fr and chiens.fr could appear in derivative browser sessions a certain percentage of the time if these sites exist, alongside the original site selected, dog.com.

For domain names selected initially that do not necessarily have a translation that can be found when searched for in the attached dictionary, such as invented trade names, a derivative website for the same name that is originally selected will be searched for, but with a foreign extension.

Again, the first extension for the similar translated derivative domain name searched for will be, by default, that which is synonymous with the language translated to.

The other extensions for the similar translated derivative domain names searched for are then based on the process of initial derivative searches described previously, where weighting quotas for domain extensions may eventually be met and extra searches may be made, as detailed.

Further derivative browser sessions are generated, if enabled by the user, based on a thesaurus attached to the program. The websites attached to original domains selected are downloaded first and thesaurus searches are simultaneously made based on the original domain names selected. The program then attempts to download derivative websites for the words found from the thesaurus' search.

One aspect of the software, if selected, allows for the findings of the thesaurus searches to be translated and then websites are searched for based on the resultant names, with added extensions. By default, this translating of the thesaurus' findings and then searching for sites to download based on these sites will be inactive, but can be activated by the user.

Again, the process of weighting based initial derivative searches, followed by extra searches if required, applies.

When a browser session is initially opened by a user and a website is selected and downloaded, one derivative browser session displays links to the other derivative sites found and downloaded. The list of links to derivative websites can appear in a window or applet in the same browser session opened up initially, instead of appearing in a different browser session.

The user will be able to select whether the links appear in the same browser session or a new browser session. The user will also be able to enable or disable the provision of this list of links to derivative websites.

Overall, by default, when a browser session is opened by a user and the website initially selected is downloaded, five other browser sessions open automatically. One browser session displays links to the other derivative websites downloaded. Two browser sessions are dedicated to actually downloading websites with the same core names, but different extensions. The remaining two browser sessions are dedicated to downloading websites with similar domain names and the same or different extensions.

The same website will not download to more than one browser session based on one initial website selection. If the same website exists under more than one domain name, then the site will still not appear more than once in any of the browser sessions running concurrently, unless these same sites are individually selected. For example, if the website attached to dogs.com is the same as dogs.net and dogs.com is selected originally, dogs.net will not appear in a derivative browser session. The browser software detects the same attributes in the code for sites that are the same, apart from for their domain names.

All default settings provided are examples and may be altered within the program.

The default settings for the generation and downloading of derivative domain names and sites respectively, based on the following criteria are disabled, but these can be separately enabled by the users of each web browser:

The downloading of derivative websites whose whole domain names are selected at random:

The downloading of derivative websites that are concerned with exactly translated and translated similar domain names:

The downloading of derivative websites whose names are based on thesaurus searches on originally selected domain names:

and downloading sites with domain names derived from translating the results of thesaurus-searches on originally selected domains.

A further option that is programmed into the software attached to the browser is the ability for the user to enable or disable the automatic generation of all types of derivative browser sessions.

If a domain extension, such as .tv has a weighting in the derivative domain extension list, derivative browser sessions for both unregistered domain names with that extension and for registered names with that extension without individual websites, cannot all redirect to one site every time. This especially applies to redirection to the sites that sell the domains with specific extensions that have a weighting.

To stop the process of the redirection of derivative browser sessions to specific sites, the browser software detects a piece of code that is placed on the sites that need to be avoided as derivative websites, as part of an agreement with the website owners, which the browser software can detect, so that these sites will not constantly appear as derivative sites.

The browser software is programmed to respond to some of the requests to visit this type of site made by the program due to derivative requests. The default setting is for the browser software to allow one in six attempts to reach a derivative site that is to generally be blocked as a derivative website.

If the derivative site found is blocked and not to be downloaded to a derivative browser session, the browser software will look to the next domain extension down in the weighting list, as previously described, to download its derivative site. However, for derivative browser sessions to be downloaded for similar domain names, if the derivative site found is not to be downloaded due to being blocked, the software will just look for another similar name with the same domain extension to download its derivative site. If two additional searches are unsuccessful, the browser will then look to the next extension down in the weighting list, as previously described.

These are the default settings, however, these can be disabled by users so that they may opt to have derivative browser sessions redirect to the same general site if a name is unregistered or there is no individual site for that domain name. It can also be re-enabled by the users.

Redirection is still be permitted outside of the use of derivative browser sessions, so that if a user initially selects an unregistered domain name or a registered name without an individual site in a browser session, the site will redirect as normal, according to the redirection policy programmed for that name by the hosts or first-hand domain name sellers.

At present, if a user of the internet enters an incomplete domain name, such as http://www.cats no site will be found from the browser's search, even if www.cats.com exists. Under this part of the invention, a domain extension is automatically added, again based on weightings preprogrammed in the browser software. This feature is enabled by default.

A further part of the invention is that multiple websites can be grouped together that may be completely different, so that when one website is downloaded that is in a group, the other specified sites within that group download automatically to other browser sessions. This is to address the problem of having to manually open separate browser windows and then separately select the domain names for the sites that a user often looks at simultaneously, to compare information across the sites for example.

An example of a grouping of websites may be:

www.register.com; www.tv and www.afternic.com.

To place websites into a group, users will simply have to enter the domain names of the sites they want grouped together into a screen dedicated to creating groups, from a drop down menu in the browser. A user's homepage can be part of a group.

There can be more than one group of websites but by default, a website cannot be part of more than one group on a user's own computer settings. The user can change this, but this may be impractical, resulting in many websites downloading one after the other.

The grouping system can be enabled or disabled by the user for all or some groups. So for example, with the above group, if enabled and www.register.com is selected to download, www.tv and www.afternic.com will also download to separate browser sessions. However, if the group is disabled and one of the sites is selected for download, such as www.register.com, the other sites in the group will not download to alternative browser sessions.

As stated, the extensions of the derivative web sites for initial derivative searches are based on preprogrammed weightings. The extensions can be separated into two or more groups. Searches for derivative websites with the extensions in the first group will take place initially. If derivative sites cannot be found with extensions listed in the first group via the process described previously of initial selections and then extra selections, searches for derivative websites will be made based on the extensions in the second group, by the same process. If not enough derivative sites can be found by searching using the extensions in the first two groups, the software will make searches based on the extensions in the third group, again by the same process and so on if there are more groups.

The first group may be:

| Domain Extension: | Percentage Weighting: |
|---|---|
| .tv | 35 |
| .info | 20 |
| .biz | 15 |
| .co.uk | 10 |
| .name | 10 |
| .pro | 10 |

The second group may be:

| Domain Extension: | Percentage Weighting: |
|---|---|
| .com | 100 |

The third group may be:

| | |
|---|---|
| .net | 80 |
| .org | 20 |

With these example groups of weightings, if one or more derivative website cannot be found after searches initiated from the first group, a .com version will be searched for definitely due to the 100% weighting for .com domains in the second group. If a website is found then with a .com extension, the next searches, if any, for derivative websites will be based on the extensions and weightings in the next group.

The derivative browser software can be applied at the website level as well as being implemented across the internet. The inventive systems described download derivative websites to browser sessions based on programs attached to the end users browser software, such as to Netscape Navigator. However, under the website application, a program is installed on websites, specifically, on the website's host servers.

At present when internet users want to open more than one browser window at once they have to keep selecting the browser icon and clicking on it for each browser window that they want opened. Under this aspect of the software there are icons that allow for multiple screens to be opened simultaneously. For example, there are icons that have the following text on them stating either ‘* 2’, ‘* 3’, ‘* 4’, which if selected cause two, three and four websites to download respectively.

The home pages that download can be the same or different ones that relate to the grouped sites pre-selected by the web users that are specific to their computer or user profile.

The prior art that exists in this area is such that when web surfers select certain websites, the programs incorporated into the websites can cause applets to appear on screen automatically and when the sites are closed down, other browser sessions can appear with other sites downloaded to them.

The program invented here operates in such a way that when surfers select a website with the program installed, derivative browser sessions, with derivative sites downloaded to them, appear on the task bar that have been pre-selected by the website's operators. Furthermore, links to the derivative pages selected by the website operator are listed on one of the derivative pages that downloads.

An example application of this program installed on websites can be provided by assuming that the website www.extreme24.tv exists with separate pages on the site dedicated to bikes, skateboarding, skiing and surfing. If the website level application of the program is installed at the website and www.extreme24.tv is selected by an internet user, first of all this page will download to the user's computer. Following this, derivative browser sessions appear on the user's task bar for the downloaded pages dedicated to bikes, skateboarding, skiing and surfing, as would a small browser session or applet with a list of links to these pages. As stated, these specific derivative browser sessions on the website installed version would have to be selected by the website operator. Furthermore, this aspect is extended with the rest of the internet, so that if the program is installed at a website such as extreme24.tv, the website operator can select any website to download as a derivative site when this site is selected by a web surfer, including external sites on the internet.

The derivative sites that appear based on this website application can be specific to individual users, based on their historic preferences when visiting the websites that offer this system, as detailed in cookies left on users' computers from previous visits. For example, a regular visitor to a business website may often visit pages dedicated to stocks and options, in which case it will be screens concerned with this topic that will download as derivative browser sessions. A website that implements the system can place any web page (or data resource) including ones from its own site in a group. Applets are also placed in groups by the website hosts, probably with the same type of content as the other web pages in the group. When a web page in a group is accessed, the other pages and applets in the same group download as derivative sites. A further implementation is for the initial webpage selected to download and then for the most frequently visited pages on a website for each individual user to download as derivative sites.

At the moment when visitors to a website want to open more than one screen at once, they must click on each link separately. When a link is selected (by clicking on it), the screen attached to the link starts to download. In order to open the other screens, they must go back to the previous screen where the relevant links are and then select them. Again, when the second link is selected a screen starts to download and the user must go back to the original page to open further relevant links. To open ten screens, for example, with content such as pictures from ten different links, is a time consuming process at present.

The software described here allows for website managers to place web page URLs in separate groups by entering them in one main field or separate fields grouped together, so that when users click on just one link, all the URLs placed in a group attached to that link, download. There are separate fields that allow the website manager to enter a reference name for each specific group of URLs and fields for the name or image that appears on the link, on the website which, when selected opens up each of the listed URLs in a group.

Bandwidth is dedicated in such a way that the screens in the group download separately. An alternative implementation is for the screens to download at the same rate, but this is not the preferred method.

At present, when links are opened for screens by website visitors, an icon appears on the task bar that represents the screen that is downloading. Under this software, when the screen has downloaded fully, the icon on the task bar changes colour. Alternatively, words on the icon can appear that have been selected and entered into a dedicated field by the website manager.

A default setting for the browser software allows for the initial website selected, any derivative websites found due to the browser level program, predetermined groups of websites and due to the website level application, to all download together, based on an initial website selection. However, by default, a maximum of eight browser sessions can appear automatically on the task bar, for these types of site downloads, along side the website originally selected. As a result, situations may arise where the full number of websites from groups, the website installed program and derivative websites from the browser level application of the software cannot download, due to the limit set.

The derivative browser sessions that have derivative websites downloaded to them can appear as small windows that can be enlarged within the browser session that was opened initially by the user, as opposed to just appearing on the task bar.

The time limit for downloading derivative websites can become modifiable to the extent that it can be reduced, as well as increased.

An alternative implementation is to install the browser level software on the users' individual computers, independently of the web browsers.

At present, the weightings apply to successful, initial derivative searches made by the program after a domain name has been originally selected, which is the preferred method. However, the weightings can be made to apply to search attempts made for an extension, regardless of whether or not a derivative site is successfully downloaded.

The records of successful derivative website downloads from the initial and extra derivative search processes can be stored over a network, as opposed to on the relevant user's computer.

Another alternative implementation is to allow the users to alter the weightings applied to the different extensions which dictate how often derivative websites are downloaded with these different extensions from initial derivative searches.

Regarding the compatibility between the website application of the program and the browser level application of the program, when a website is originally selected by a user:—A specific piece of program code can be embedded in the home pages of websites that have the website program installed on them. When this code is detected by the browser level application of the program, any further derivative websites from the browser level application of the software or that are in groups, can cease to be downloaded for that specific initial website selection. This limits the number of browser sessions open at one time.

1. A method of accessing a plurality of remote data resources, the method comprising the steps of:
receiving a locator for a single remote data resource;
identifying a generic portion of said single remote data resource locator and a distinctive portion of said single remote data resource locator;
modifying the generic portion or the distinctive portion of said single remote data resource locator to create one or more new remote data resource locators; and
accessing the remote data resources located by the received single remote data resource locator and said one or more created remote data resource locators.

2. A method according to claim 1 wherein said distinctive portion of said single remote data resource locator is translated into one or more different languages.

3. A method according to claim 2 wherein a new generic portion is selected for each translated distinctive remote data resource locator in accordance with the translation language.

4. A method according to claim 1, wherein one or more further generic remote data resource locator portions are generated and each of said generated generic portions is combined with the distinctive portion of said single remote data resource locator to create one or more new remote data resource locators.

5. A method according to claim 4 wherein the one or more further generic remote data resource locator portions are chosen randomly from a plurality of generic remote data resource locator portions.

6. A method according to claim 5 wherein the one or more further generic remote data resource locator portions are chosen randomly from a plurality of generic remote data resource locator portions, each of said plurality of generic remote data resource locator portions having an equal probability of being chosen.

7. A method according to claim 5 wherein the one or more further generic remote data resource locator portions are chosen randomly from a plurality of generic remote data resource locator portions, each of said plurality of generic remote data locator resource portions having a respective predetermined probability of being chosen.

8. A method according to claim 7 in which each respective predetermined probability of being chosen is constant.

9. A method according to claim 7 in which one or more of said respective predetermined probabilities of being chosen may be varied.

10. A method according to claim 1, wherein the one or more further generic portions indicate a geographical location.

11. A method according to claim 1, wherein the one or more further generic portions indicate an organisational descriptor.

12. A method according to claim 1, wherein one or more further distinctive portions are created by adding one or more generic sequence into said distinctive data resource locator portion.

13. A method according to claim 1, wherein one or more further distinctive portions are created by removing one or more generic sequence from said distinctive data resource locator portion.

14. A method according to claim 1, wherein one or more further distinctive portions are created by processing said distinctive data resource locator portion to create one or more synonyms.

15. A method according to claim 1, wherein said single remote data resource locator comprises solely a distinctive portion and a plurality of remote data resource locators are created by generating a plurality of generic remote data resource locator portions and combining these with said distinctive portion.

16. A computer program arranged to receive a locator for a single remote data resource;
identify a generic portion of said single remote data resource locator and a distinctive portion of said single remote data resource locator;
modify the generic portion or the distinctive portion of said single remote data resource locator to create one or more new remote data resource locators; and
access the remote data resources located by the received single remote data resource locator and said one or more created remote data resource locators.

17. A computer terminal attached to a communications network arranged to
receive a locator for a single remote data resource located on the communications network;
identify a generic portion of said single remote data resource and a distinctive portion of said single remote data resource;
modify the generic portion or the distinctive portion of said single remote data resource to create one or more new remote data resource locators; and
access via the communications network the remote data resources located by the received single remote data resource locator and said one or more created remote data resource locators.

18. A server attached to a communications network arranged to
receive a locator for a single data resource located on the communications network;
identify a generic portion of said single data resource and a distinctive portion of said single data resource;
modify the generic portion or the distinctive portion of said single data resource to create one or more remote data resource locators;
(i) serve via the communications network the data resource located by the received single data resource locator; and
(ii) serve via the communications network the one or more data resource located by said respective one or more created remote data resource locators.

19. A server attached to a communications network arranged to
receive a locator for a single data resource located on the communications network;
identifying one or more further remote data resource locators that are associated with said single remote data resource locator; and
serve via the communications network said single remote data resource locator and said associated one or more remote data resource locators.

20. A server according to claim 19, wherein said associated one or more remote data resource locators are identified by a data set stored on a remote terminal.

21. A method of accessing a plurality of remote data resources, the method comprising the steps of:
receiving a single remote data resource locator;
identifying one or more further remote data resource locators that are associated with said single remote data resource locator; and
accessing said single remote data resource locator and said associated one or more remote data resource locators.

22. A method according to claim 21 wherein said associated one or more remote data resource locators are identified by a data set stored on a remote terminal.

23. A method according to claim 21 wherein the association of said one or more further remote data resource locators with said single remote data resource locator may be configured.

24. A method according to claim 23 wherein said association is may be configured by a user.

25. A method of accessing a plurality of remote data resources, the method comprising the steps of:
receiving a locator for a single remote data resource;
accessing the remote data resource identified by said locator;
analysing the remote data resource to generate one or more distinctive remote data resource locator portions;
creating one or more remote data resource locators by combining said one or more distinctive remote data resource locator portions with a respective generic remote data resource locator portion; and
accessing the remote data resource located by said created one or more remote data resource locators.
